(19) United States
(12) Patent Application Publication
(10) Pub. No.: US 2015/0053069 A1
(43) Pub. Date: Feb. 26, 2015

(54) MAGNETIC PICKUP FOR GUITAR

(71) Applicants: James David Heil, Cathedral City, CA (US); Mark Ray Gregg, Palm Springs, CA (US)

(72) Inventors: James David Heil, Cathedral City, CA (US); Mark Ray Gregg, Palm Springs, CA (US)

(21) Appl. No.: 13/973,882

(22) Filed: Aug. 22, 2013

(51) Int. Cl. G10H 3/18

(52) U.S. Cl. CPC G10H 3/181
USPC 84/726

(57) ABSTRACT

An aspect of the invention is a magnetic pickup for a stringed musical instrument. The aspect includes a bobbin wherein the bobbin includes a magnetic pole piece and a winding of wire configured to be wound thereabout the bobbin, a magnetic material disposed adjacent to the bobbin; a base plate adjacent the magnetic material and wherein the winding of wire is comprised of a silver material.

### FIELD OF THE INVENTION

The present invention relates generally to commodity purchasing and more particularly to a magnetic pickup for a stringed musical instrument

### BACKGROUND OF THE INVENTION

To produce sound, an electric guitar senses the vibrations of the strings electronically and routes an electronic signal to an amplifier and speaker. The sensing occurs in a magnetic pickup mounted under the strings on the guitar's body. There are two basic pickup types, magnetic pickups and piezoelectric pickups. The latter type work with all kinds of strings (steel, nylon, or gut). Magnetic pickups work only with steel strings, and consist of magnets and coils. Single-coil pickups are sensitive to magnetic fields generated by transformers, fluorescent lamps, and other sources of interference, and are prone to pick up hum and noise from these sources. Dual coil or “humbucking” pickups use two specially configured coils to minimize this interference. Because these coils are electrically out of phase, common-mode signals (i.e. signals such as hum that radiate into both coils with equal amplitude) cancel each other.

The arrangement of the magnets is different for different pickups. Some types have rod or bar magnets inserted directly in the coils, while others have magnets below the coils, and cores of soft iron in the coils. In many cases these cores are screws, so level differences between strings can be evened out by screwing the core further in or out. Some pickups have a metal cover for shielding and protection of the coils, others have a plastic cover that does not shield against electromagnetic interference, and still others have only isolating tape for protecting the wire.

The magnetic field lines flow through the coil(s) and a short section of the strings. With the strings at rest, the magnetic flux through the coil(s) is constant. Pluck a string and the flux changes, which will induce an electric voltage in the coil. A vibrating string induces an alternating voltage at the frequency of vibration, where the voltage is proportional to the velocity of the strings motion (not its amplitude). Furthermore, the voltage depends on the string's thickness and magnetic permeability, the magnetic field, and the distance between the magnetic pole and the string.

There is one major undesirable disadvantage of the single coil style magnetic Pickup—it picks the electromagnetic noise from the surrounding space, where the magnetic pickup is exposed. Electromagnetic noises in the space are generally produced and radiated by power transformers, power diode rectifiers, electric motors etc.

There are a few conventional methods, which use dual coil magnetic pickup assemblies to cancel that undesirable electromagnetic noise. One of these methods is called classic humbucking pickup, which includes two side-by-side positioned identical coils permanently or switchably connected in series or in parallel. Another popular method uses two stacked (one on the top of the other) identical single coil windings permanently or switchable connected in series or in parallel. These two most popular methods, generally cancel the undesirable noise but they also change the musical specter of the generated audio electric signal in one or another way. The frequency response, the phase and harmonic content of the generated audio electric signal are changed too.

Consequently, what is needed is a magnetic pickup that addresses the above-described problems associated with the conventional methodology. The present invention addresses this need.

### SUMMARY OF INVENTION

An aspect of the invention is a magnetic pickup for a stringed musical instrument. The aspect includes a bobbin wherein the bobbin includes a magnetic pole piece and a winding of wire configured to be wound thereabout the bobbin, a magnetic material disposed adjacent to the bobbin; a base plate adjacent the magnetic material and wherein the winding of wire is comprised of a silver material.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 illustrates a pickup in accordance with an embodiment.

FIG. 2 is an illustration of an alternate configuration of a pickup in accordance with an embodiment.

FIG. 3 shows an alternate configuration of a pickup in accordance with an embodiment.

A magnetic pickup for a guitar is disclosed. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

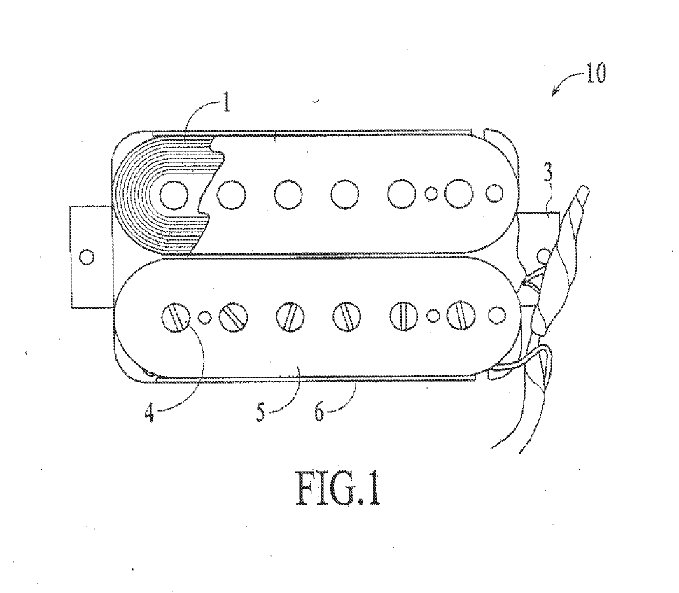

FIG. 1 shows a top view of magnetic pickup 10 in accordance with an embodiment of the present invention. The pickup 10 includes wire wrapping 1, at least one adjustable screw 4, a bobbin 5 and a base plate 6. In an embodiment, the bobbin 5 is made of a plastic material. Preferably, the pickup 10 is positioned beneath the strings of a stringed instrument, such as an electric guitar and is fastened to the body of the instrument by means of fastening holes in a mounting foot 3.

In varying embodiments, the wire wrapping is designed with a plated copper alloy. In a specific embodiment, the wire wrapping 1 is comprised of various elements which include from 2% to 20% silver plating a copper strand. The implementation of this design feature makes up for the difference between the sound produced by copper smelted with 50's era technology and impurities left therein and the sound produced by the more pure copper produced today without the various elements and contaminants of the past. Because the copper is plated with silver and other elements, the high frequencies from the guitar actually travel on the “skin” making it similar but not exactly the same as pure silver which increases conductance. This produces a far superior tone from the pickup than the conventional wind.

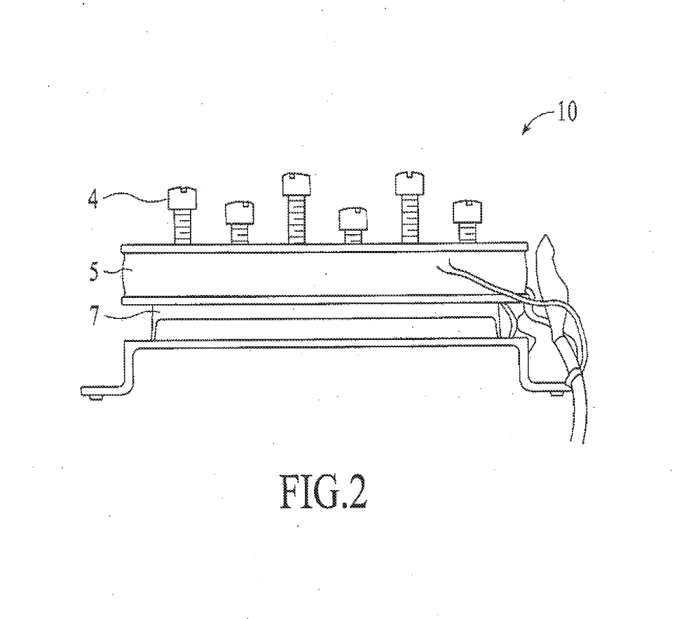

FIG. 2 shows a side view of the magnetic pickup 10 in accordance with an embodiment of the present invention. The side view shows the adjustable screw 4, the bobbin 5 and a magnetic material 7. In this embodiment, the magnetic material 7 is located adjacent to the bobbin 5 and comprises an Alnico magnetic material wherein the Alnico magnetic material is baked to 320 degrees F. then frozen at 10 degrees F. for 10 hours. This treatment is implemented to fatigue the magnet and induce artificial aging.

Although the above described embodiment is disclosed in the context of being used in conjunction with silver, one of ordinary skill will readily recognize that a variety of different materials could be used while remaining within the spirit and scope of the present inventive concepts.

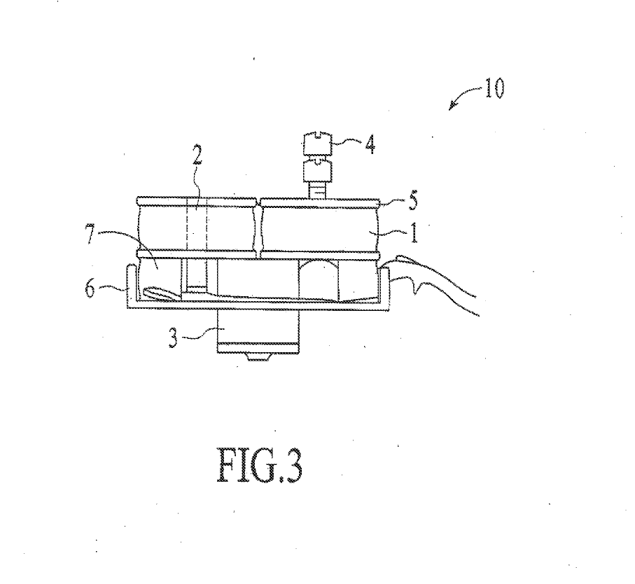

FIG. 3 shows an alternate view of the magnetic pickup 10 in accordance with an embodiment of the present invention. FIG. 3 shows a slug 2 located within the pickup 10 adjacent to the magnetic material 7 and its purpose is to translate the magnetic field in and around the string. Ideally, when the bobbin 5 is half wound, a rice grain capacitor at 0.047 mfd is connected in series prior to magnetizing the slug 2 and screws 4 to boost mili voltage created by the said windings which an output gain exceeding the volume of conventional pickup.

Without further analysis, the foregoing so fully reveals the gist of the present inventive concepts that others can, by applying current knowledge, readily adapt it for various applications without omitting features that, from the standpoint of prior art, fairly constitute essential characteristics of the generic or specific aspects of this invention. Therefore, such applications should and are intended to be comprehended within the meaning and range of equivalents of the following claims. Although this invention has been described in terms of certain embodiments, other embodiments that are apparent to those of ordinary skill in the art are also within the scope of this invention, as defined in the claims that follow.

1. A magnetic pickup for a stringed musical instrument comprising:
a bobbin comprising a magnetic pole piece and a winding of wire configured to be wound thereabout the bobbin;
a magnetic material disposed adjacent to the bobbin;
a base plate adjacent the magnetic material; and
wherein the winding of wire is comprised of a silver material.

2. The pickup of claim 1 wherein the silver material is a silver/copper composite.

3. The pickup of claim 2 wherein the silver copper composite comprises substantially 20% silver.

4. The pickup of claim 3 wherein the substantially 20% silver comprises a single poly coat.

5. The pickup of claim 4 wherein the single poly coat is substantially 0.070″ in diameter.

6. The pickup of claim 2 wherein the silver/copper composite includes pure copper.

7. The pickup of claim 6 wherein the pure copper is substantially 0.060″ in diameter.
